(19) United States
(12) Patent Application Publication
(10) Pub. No.: US 2026/0025094 A1
(43) Pub. Date: Jan. 22, 2026

(54) POWER GENERATION SYSTEM ASSEMBLY USING SOLAR AND WIND POWER

(71) Applicant: Billian Ducwong HYUN, Artesia, CA (US)

(72) Inventor: Billian Ducwong HYUN, Artesia, CA (US)

(21) Appl. No.: 18/902,166

(22) Filed: Sep. 30, 2024

(30) Foreign Application Priority Data
Jul. 22, 2024 (KR) 10-2024-0096281

(51) Int. Cl. H02S 10/12; F03D 3/00

(52) U.S. Cl. CPC H02S 10/12; F03D 3/005; F05B 2240/213

(57) ABSTRACT

Provided is a power generation system assembly using solar and wind power including: a first power generation structure where a first power generator using solar power is disposed and which is formed by a combined structure of a first upper panel, a first lower panel, and a first support; a second power generation structure where a second power generator using wind power is disposed and which is formed by a combined structure of a second upper panel, a second lower panel, and a second support such that the second power generator is disposed in or separated from an inner space of the first power generation structure; and a support member provided between the first lower panel and the second lower panel to prevent the second lower panel from sagging due to a weight of the second power generator.

### BACKGROUND

### 1. Field of the Invention

The present invention relates to a power generation system, and more specifically, to a power generation system assembly in which power generators using solar and wind power are installed in a stacked manner and used or a power generator using wind power is separated and used.

### 2. Discussion of Related Art

In general, the interest in and the need for new renewable energy are increasing, and thus the trend is that combined power generation systems for generating electrical energy using solar and wind power are being developed.

That is, such a combined power generation system can generate electrical energy by an independent power generation system using wind power and a power generation system using solar power installed adjacent thereto.

However, the combined power generation system using solar power not only occupies a large installation area, but also is fixed and cannot be moved and used.

### SUMMARY OF THE INVENTION

The present invention is directed to providing a power generation system assembly using solar and wind power in which a power generator using solar power and a power generator using wind power are installed in a stacked manner, or an installation location of the power generator using wind power can be changed as needed.

According to an aspect of the present invention, there is provided a power generation system assembly using solar and wind power, including a first power generation structure in which a first power generator using solar power is disposed and which is formed by a combined structure of a first upper panel, a first lower panel, and a first support, a second power generation structure in which a second power generator using wind power is disposed and which is formed by a combined structure of a second upper panel, a second lower panel, and a second support such that the second power generator is disposed in or separated from an inner space of the first power generation structure, and a support member which is provided between the first lower panel and the second lower panel to prevent the second lower panel from sagging due to a weight of the second power generator when the second power generation structure in which the second power generator is disposed is disposed in the inner space of the first power generation structure.

In addition, the first upper panel may be formed to be inclined at a predetermined angle.

In addition, the first power generator may include at least one solar collector.

In addition, the second power generator may include a blade having one end and the other end from which shaft parts are formed to protrude and rotated by wind flowing into a space between the second upper panel and the second lower panel, a rotor which is rotated by the shaft part formed to protrude from the one end of the blade and in which a through hole through which the shaft part passes is formed in a central portion of the rotor and a plurality of magnets are disposed on a surface of the rotor adjacent to the through hole as a center, and a stator which is fixed in contact with the second lower panel and faces the rotor, in which a first bearing to which the shaft part passing through the through hole is coupled is formed in a central portion of the stator and a stator coil is disposed on a surface of the stator adjacent to the first bearing as a center, and which generates electrical energy according to the rotation of the rotor.

In addition, the magnets are permanent magnets of which N-poles and S-poles are alternately disposed.

In addition, the rotor and the stator may be disk-shaped structures.

In addition, a fixed plate may be provided in contact with one surface of the second upper panel, a second bearing coupled to the shaft part formed to protrude from the other end of the blade may be connected to the fixed plate, and the fixed plate and the second bearing may be connected to a rubber elastic spring which prevents the rotor from being separated from the stator.

In addition, the support member may include a fixed support having an upper end at which a first spiral portion is formed and disposed on the first lower panel, a lifting and lowering support having an inner surface on which a second spiral portion corresponding to the first spiral portion is formed and of which height is adjusted by being tightened or loosened by a rotating tool so as to come into contact with the second lower panel, and rotation guide protrusions which are formed at predetermined intervals to protrude from an outer surface of the lifting and lowering support and in which catching grooves fastened to both ends of the rotating tool are formed at one side and the other side of each of the rotation guide protrusions.

In addition, the support member may include a cylindrical portion which is disposed on the first lower panel and of which upper portion is open, a reinforcing part formed in an inner space of the cylindrical portion, a fixed support having an upper end at which a first spiral portion is formed and having a cover shape for sealing the open upper portion of the cylindrical portion, a lifting and lowering support having an inner surface on which a second spiral portion corresponding to the first spiral portion is formed and of which height is adjusted by being tightened or loosened by a rotating tool so as to come into contact with the second lower panel, and rotation guide protrusions which are formed at predetermined intervals to protrude from an outer surface of the lifting and lowering support and in which catching grooves fastened to both ends of the rotating tool are formed at one side and the other side of each of the rotation guide protrusions.

In addition, quadrangular ring parts which allow the support member to be moved using a separating tool may be formed on both sides of an outer circumferential surface of the fixed support or both sides of an outer circumferential surface of the cylindrical portion.

In addition, the rotating tool may include a linear rotating rod having a wedge part that is formed at one end thereof comes into contact with the catching groove formed at the one side or the other side of the rotation guide protrusion to push the rotation guide protrusion to rotate the lifting and lowering support in a first direction or a second direction opposite to the first direction, a hook-shaped rotating rod having a hooking protrusion that is formed at one end thereof and is caught in the catching groove formed at the one side or the other side of the rotation guide protrusion to catch and pull the rotation guide protrusion to rotate the lifting and lowering support in the first direction or the second direction opposite to the first direction, a coil spring from which the linear rotating rod and the hook-shaped rotating rod extend in parallel and which guides widening or narrowing movement of the linear and hook-shaped rotating rods, and left and right handles formed at both ends of the coil spring.

In addition, the separating tool may include a pair of separating rods having hooking protrusions formed at one ends to be caught in ring parts of a fixed support or a cylindrical portion, a coil spring from which the pair of separating rods extend in parallel and which guides widening or narrowing movement of the separating rods, and left and right handles formed at both ends of the coil spring.

In addition, the movement of the cylindrical portion may be restricted by a pedal.

In addition, electrical charging lines of the first power generator and the second power generator may be connected to the storage battery in parallel, on/off contact parts that determine whether to charge the storage battery are formed on the electrical charging lines, and the on/off contact parts are controlled to be turned on or off by a control switch of a control terminal.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a combined power generation system assembly using solar and wind power according to an embodiment of the present invention;

FIG. 2 is a schematic front view of the power generation system assembly using solar and wind power according to the embodiment of the present invention;

FIG. 3 is a schematic side view of the power generation system assembly using solar and wind power according to the embodiment of the present invention;

FIG. 4 is an exploded perspective view illustrating a structure of a second power generator using wind power according to the embodiment of the present invention;

FIG. 5 is a schematic plan view illustrating a structure of a stator of the second power generator according to the embodiment of the present invention;

FIG. 6 is a schematic plan view illustrating a structure of a rotor of the second power generator according to the embodiment of the present invention;

FIG. 7 is a perspective view illustrating a coupled structure of a support member according to the embodiment of the present invention;

FIG. 8 is an exploded perspective view illustrating the structure of the support member according to the embodiment of the present invention;

FIG. 9 is a perspective view illustrating the coupling of the support member and a rotating tool according to the embodiment of the present invention;

FIG. 10A is a schematic plan view illustrating a state in which a height of the support member is raised using the rotating tool according to the embodiment of the present invention;

FIG. 10B is a schematic cross-sectional view illustrating the state in which the height of the support member is raised using the rotating tool according to the embodiment of the present invention;

FIG. 11A is a schematic plan view illustrating a state in which the height of the support member is lowered using the rotating tool according to the embodiment of the present invention;

FIG. 11B is a schematic cross-sectional view illustrating the state in which the height of the support member is lowered using the rotating tool according to the embodiment of the present invention;

FIG. 12 is a schematic block diagram of a state in which electrical energy generated by a first power generator and the second power generator is charged according to the embodiment of the present invention;

FIG. 13 is a perspective view of a combined power generation system assembly using solar and wind power to which a support member having a raised height is applied according to another embodiment of the present invention;

FIG. 14 is a perspective view of a structure of the coupled support member having a raised height according to another embodiment of the present invention;

FIG. 15 is an exploded perspective view of the structure of the support member having a raised height according to another embodiment of the present invention;

FIG. 16 is a schematic plan view of a structure of a separating tool having a pedal for moving the support member having a raised height according to another embodiment of the present invention; and

FIG. 17 is a schematic plan view of a state in which the support member is separated using the separating tool having a pedal according to another embodiment of the present invention.

### DETAILED DESCRIPTION OF EXEMPLARY EMBODIMENTS

Hereinafter, an embodiment of the present invention will be described with reference to the accompanying drawings.

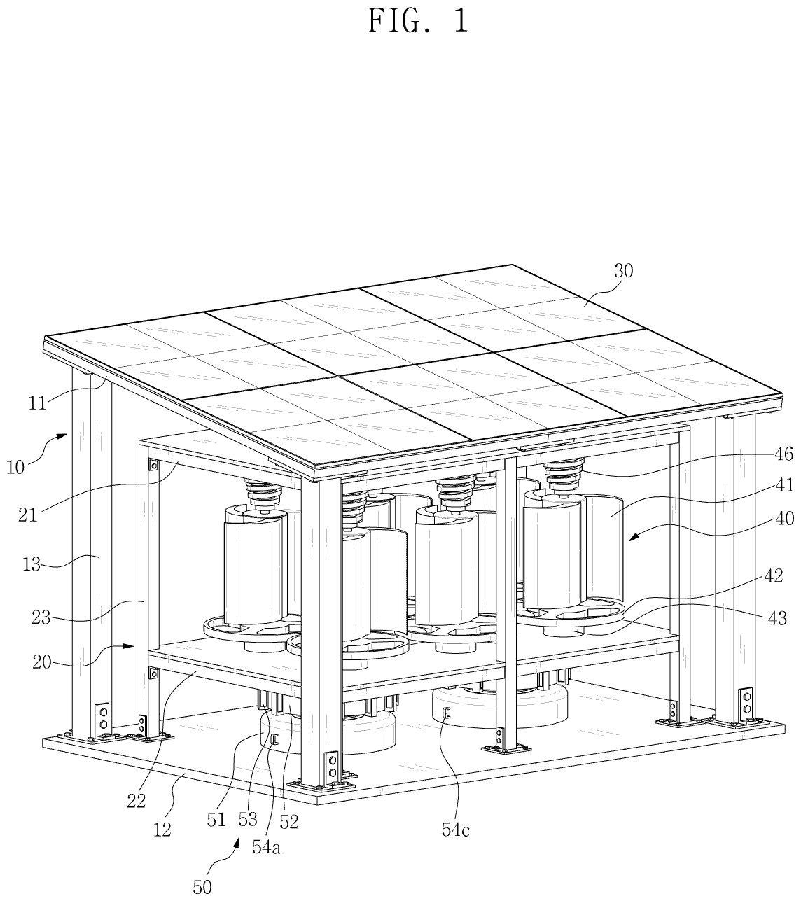

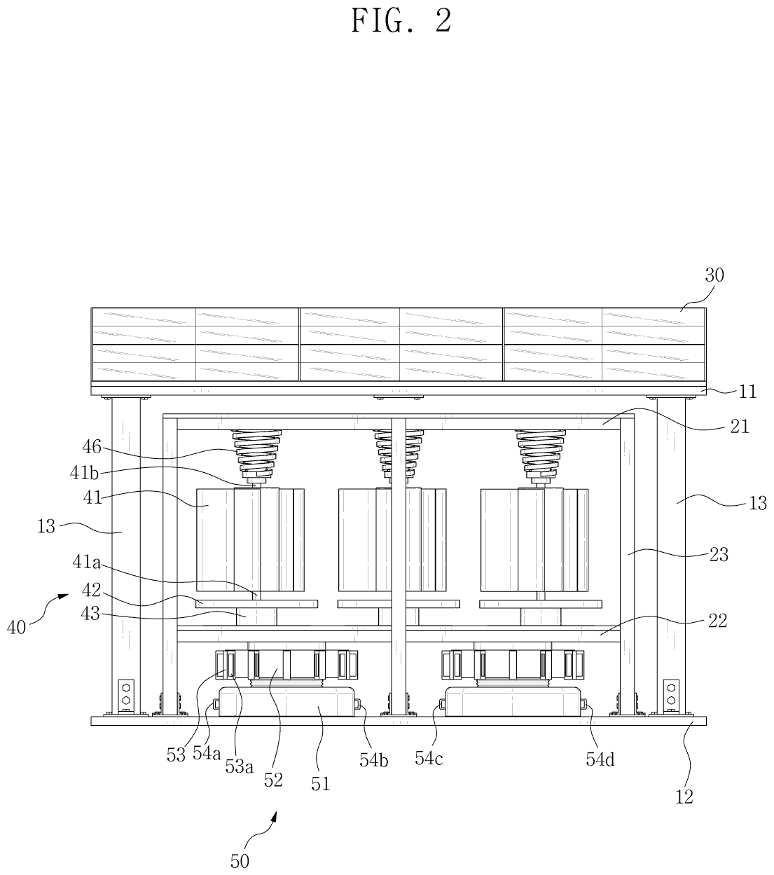

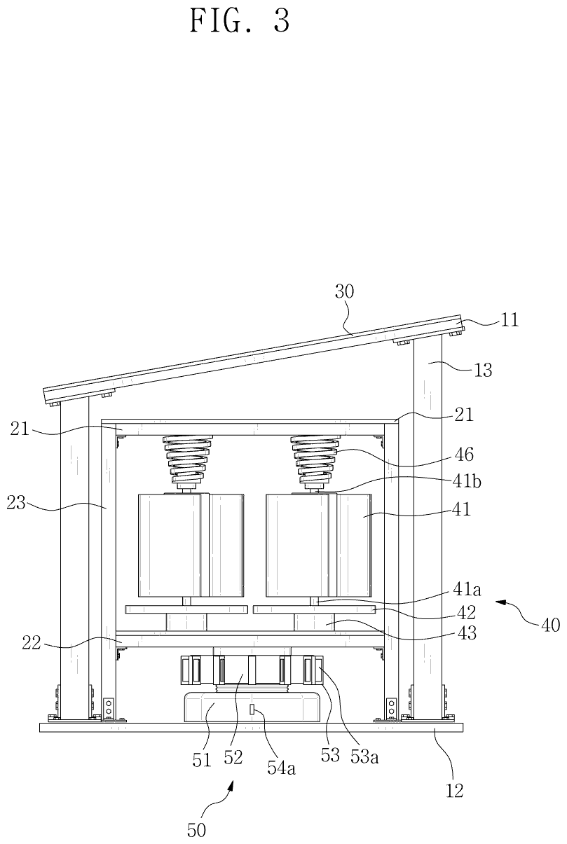

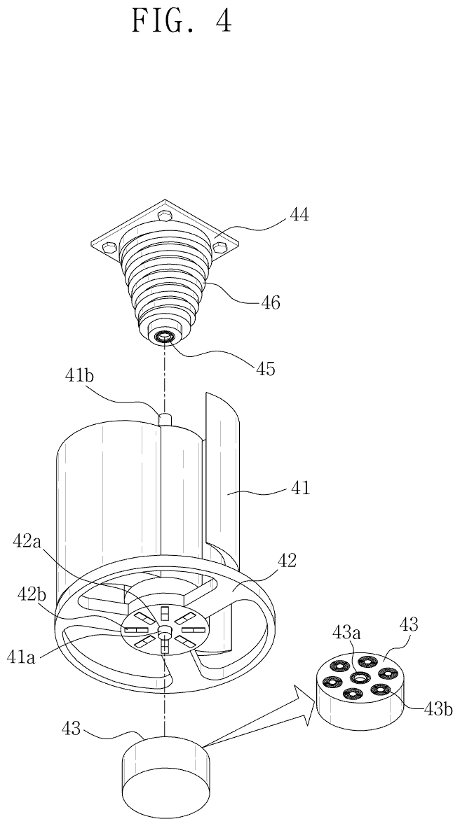

FIG. 1 is a perspective view of a combined power generation system assembly using solar and wind power according to an embodiment of the present invention, and FIG. 2 is a schematic front view of the power generation system assembly using solar and wind power according to the embodiment of the present invention. FIG. 3 is a schematic side view of the power generation system assembly using solar and wind power according to the embodiment of the present invention, and FIG. 4 is an exploded perspective view illustrating a structure of a second power generator using wind power according to the embodiment of the present invention.

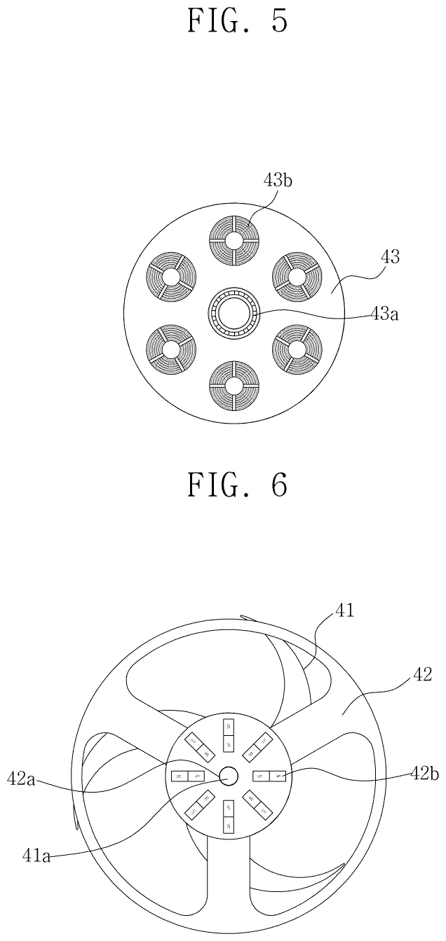

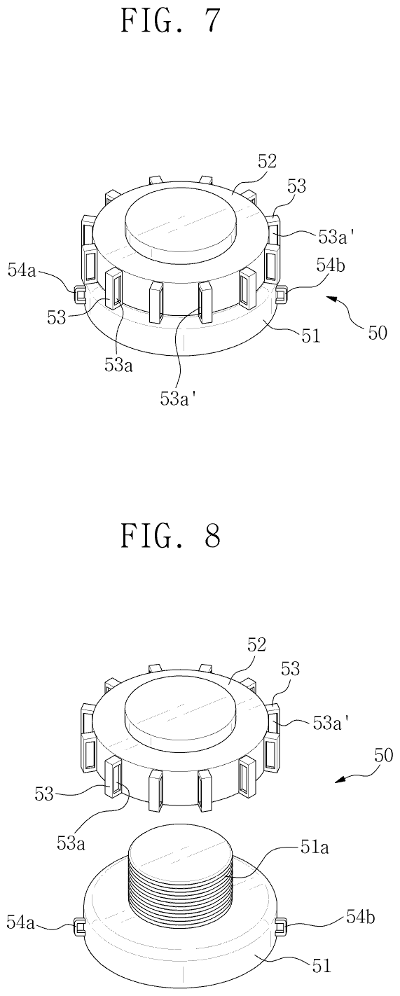

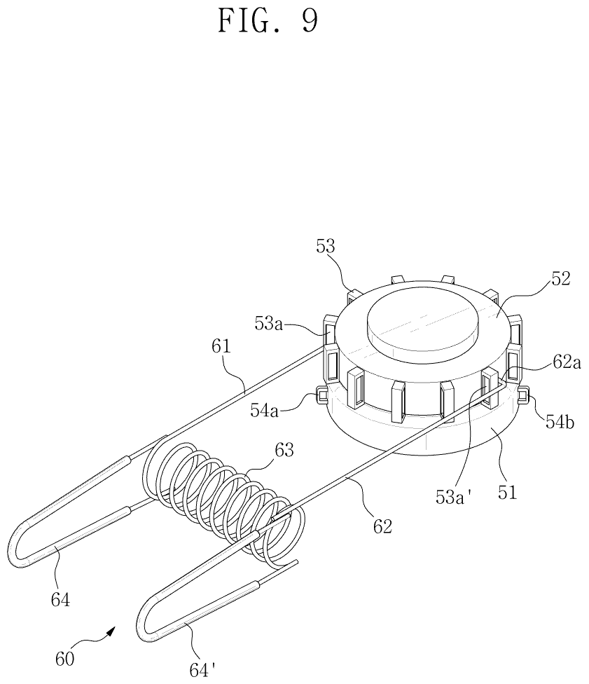

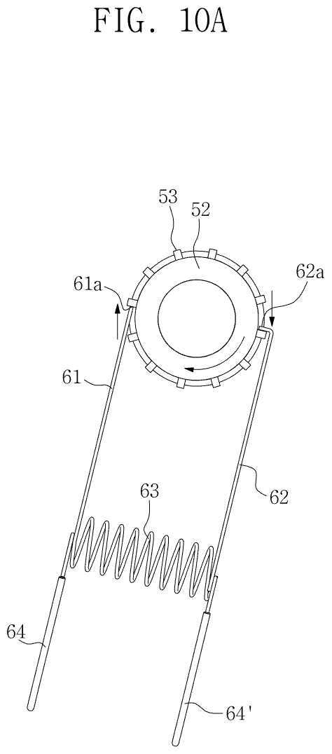

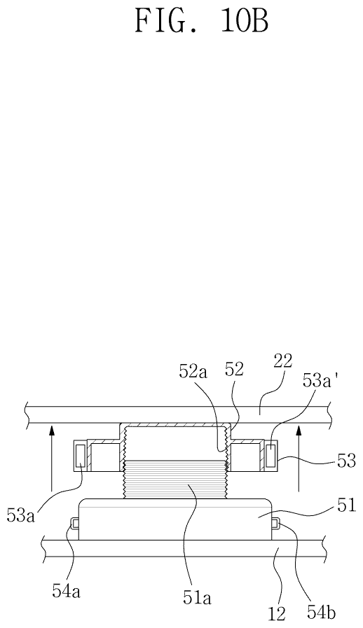

FIG. 5 is a schematic plan view illustrating a structure of a stator of the second power generator according to the embodiment of the present invention, and FIG. 6 is a schematic plan view illustrating a structure of a rotor of the second power generator according to the embodiment of the present invention. FIG. 7 is a perspective view illustrating a coupled structure of a support member according to the embodiment of the present invention, FIG. 8 is an exploded perspective view illustrating the structure of the support member according to the embodiment of the present invention, and FIG. 9 is a perspective view illustrating the coupling of the support member and a rotating tool according to the embodiment of the present invention.

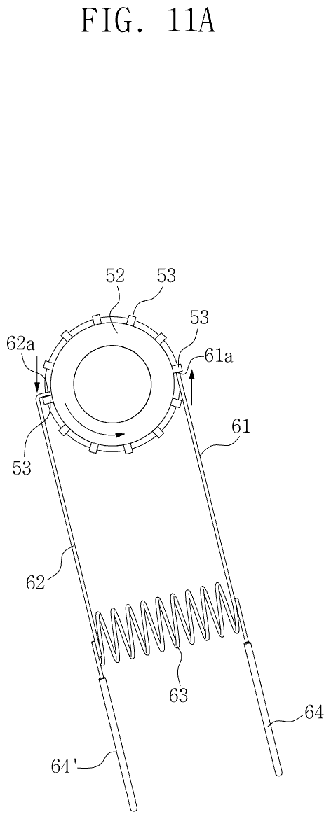

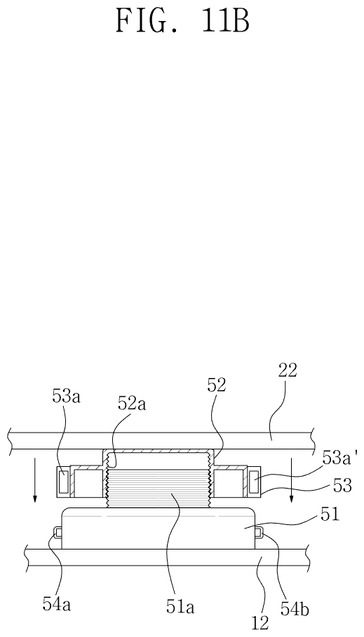

FIG. 10A is a schematic plan view illustrating a state in which a height of the support member is raised using the rotating tool according to the embodiment of the present invention, and FIG. 10B is a schematic cross-sectional view illustrating the state in which the height of the support member is raised using the rotating tool according to the embodiment of the present invention. FIG. 11A is a schematic plan view illustrating a state in which the height of the support member is lowered using the rotating tool according to the embodiment of the present invention, and FIG. 11B is a schematic cross-sectional view illustrating the state in which the height of the support member is lowered using the rotating tool according to the embodiment of the present invention.

Referring to FIGS. 1 to 11, in the power generation system assembly using solar and wind power according to the embodiment of the present invention, a first power generator 30 using solar power and a second power generator 40 using wind power are provided in a stacked manner and can be used at the same time or separately. The power generation system assembly using solar and wind power includes a first power generation structure 10, a second power generation structure 20, the first power generator 30, the second power generator 40, a support member 50, and/or a rotating tool 60.

The first power generation structure 10 is where the first power generator 30 using solar power is installed, and is formed by a combined structure of a first upper panel 11, a first lower panel 12, and a first support 13.

The first power generator 30 for generating electrical energy using solar power is disposed on the first upper panel 11, and at least one solar collector constituting the first power generator 30 is disposed on one surface of the first upper panel 11 inclined at a predetermined angle.

The first lower panel 12 is a panel structure in contact with the ground.

The first support 13 is a column structure supporting the first upper panel 11 and the first lower panel 12.

The second power generation structure 20 is where the second power generator 40 using wind power is installed, is formed by a combined structure of a second upper panel 21, a second lower panel 22, and a second support 23, and the second power generator 40 for generating electrical energy using wind power may be disposed in a space formed between the second upper panel 21 and the second lower panel 22.

The second upper panel 21 supports an upper portion of the second power generator 40 for generating electrical energy using wind power, the second lower panel 22 is a support panel structure, and the second support 23 is a column structure supporting the second upper panel 21 and the second lower panel 22.

Here, the second power generation structure 20 formed by the combined structure of the second upper panel 21, the second lower panel 22, and the second support 23 may have a size that is accommodated in a space between the first upper panel 11 and the first lower panel 12 constituting the combined structure of the first power generation structure 10 to form a stacked structure. In addition, the second power generation structure 20 may be freely separated from the space between the first upper panel 11 and the first lower panel 12.

That is, the first power generation structure 10 and the second power generation structure 20 may form a stacked structure, or the second power generation structure 20 may be separated from the first power generation structure 10 and independently used as a power generation system using wind power.

Here, as the second power generator 40 is a module structure including a blade 41, a rotor 42, and a stator 43, shaft parts 41a and 41b are formed to protrude from one end and the other end of the blade 41, and the blade 41 is rotated by wind flowing into the space between the second upper panel 21 and the second lower panel 22.

The rotor 42 may be rotated by the shaft part 41a formed to protrude from one end of the blade 41, a through hole 42a through which the shaft part 41a passes may be formed in a central portion of the rotor 42, a plurality of magnets 42b may be disposed on a surface adjacent to a center of the through hole 42a.

The stator 43 is fixed in contact with the second lower panel 22 to face the rotor 42, a first bearing 43a coupled to the shaft part 41a passing through the through hole 42a is formed in a central portion of the stator 43, a stator coil 43b is disposed on a surface adjacent to the first bearing 43a as a center, and the stator 43 generates electrical energy according to the rotation of the rotor 42.

Here, the magnets 42b are permanent magnets of which N-poles and S-poles are alternately disposed, and the rotor 42 and the stator 43 may be disk-shaped structures.

Meanwhile, a fixed plate 44 included in the second power generator 40 may be provided in contact with one surface of the second upper panel 21, a second bearing 45 coupled to the shaft part 41b formed to protrude from the other end of the blade 41 may be connected to the fixed plate 44, the fixed plate 44 and the second bearing 45 may be provided to be connected to a rubber elastic spring 46 for preventing the rotor 42 from being separated from the stator 43, and thus a fixed state of the second power generator 40 may be firmly maintained in the space between the second upper panel 21 and the second lower panel 22 by an elastic force provided by the rubber elastic spring 46 without using an additional fixing means, and disassembly work may also be easily performed by applying an external force without using an additional apparatus.

That is, the shaft part 41a under the blade 41 may be rotatably coupled to the first bearing 43a included in the stator 43, the shaft part 41b above the blade 41 may be rotatably coupled to the second bearing 45 connected to the fixed plate 44 through the rubber elastic spring 46, and thus a stable fixed state of the second power generator 40 may be maintained in the space between the second upper panel 21 and the second lower panel 22.

The support member 50 is provided under the second lower panel 22 included in the second power generation structure 20, and as a height of the support member 50 is adjusted by the rotating tool 60, the second lower panel 22 is prevented from sagging due to the weight of the second power generator 40.

That is, as the height of the support member 50 is adjusted by the rotating tool 60, the stator 43 included in the second power generator 40 may be fixed by coming into contact with one surface of the second lower panel 22, the fixed plate 44 included in the second power generator 40 may be in fixed by coming into contact with one surface of the second upper panel 21 facing one surface of the second lower panel 22, and accordingly, the support member 50 includes a fixed support 51, a lifting and lowering support 52, and rotation guide protrusions 53.

A first spiral portion 51a is formed at the top of the fixed support 51, and the fixed support 51 is disposed on an upper surface of the first lower panel 12.

Here, quadrangular ring parts 54a, 54b, 54c, and 54d may be formed to protrude from both sides of an outer circumferential surface of the fixed support 51 to allow the support member 50 to be moved using a separating tool 70.

A second spiral portion 52a corresponding to the first spiral portion 51a is formed on an inner surface of the lifting and lowering support 52, and a height of the lifting and lowering support 52 is adjusted by being tightened or loosened by the rotating tool 60 so as to come into contact with the second lower panel 22.

That is, the height can be adjusted as the lifting and lowering support 52 rises as in FIG. 10B or descends as in FIG. 11B according to a loosening direction or tightening direction of the first and second spiral portions 51a and 52a.

The rotation guide protrusions 53 are formed at predetermined intervals to protrude from an outer surface of the lifting and lowering support 52, and catching grooves 53a and 53a′ fastened to both ends of the rotating tool 60 are formed at one side and the other side of each of the rotation guide protrusions 53.

The rotating tool 60, which is manipulated by a worker, includes a rotating rod 61 having a linear shape, a rotating rod 62 having a hook shape, a coil spring 63, and left and right handles 64 and 64′.

A wedge part 61a which comes into contact with the catching groove 53a or 53a′ formed at one side or the other side of the rotation guide protrusion 53 and pushes the rotation guide protrusion 53 to rotate the lifting and lowering support 52 in a first direction (clockwise) or second direction (counterclockwise) opposite to the first direction is formed at one end of the linear rotating rod 61.

A hooking protrusion 62a which is caught in the catching groove 53a or 53a′ formed at one side or the other side of the rotation guide protrusion 53 and catches and pulls the rotation guide protrusion 53 to rotate the lifting and lowering support 52 in the first direction or the second direction opposite to the first direction is formed by being bent at one end of the hook-shaped rotating rod 62.

The linear rotating rod 61 and the hook-shaped rotating rod 62 extend from the coil spring 63 in parallel, and the coil spring 63 guides the widening or narrowing movement of the linear and hook-shaped rotating rods 61 and 62.

The left and right handles 64 and 64′ are formed at both ends of the coil spring 63.

Here, the rotating tool 60 has a size that may be manipulated by a single worker or a plurality of workers according to an installation capacity of the power generation system, but the present invention is not necessarily limited thereto, and rotating tool 60 may also be used after being fixed to an additional apparatus.

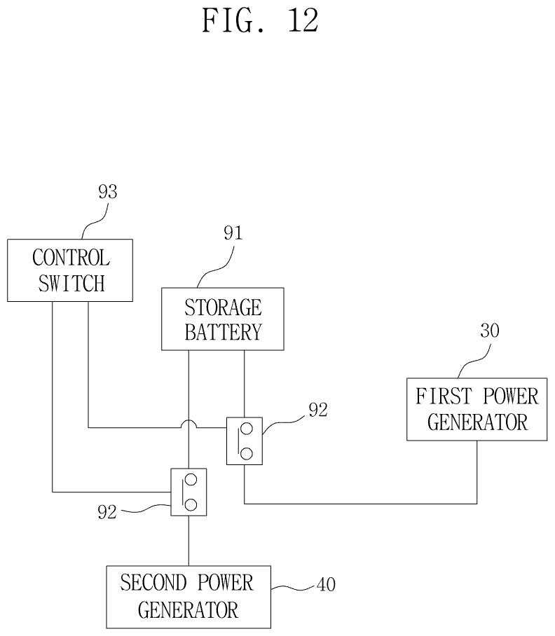

Meanwhile, in the power generation system according to the embodiment of the present invention, as illustrated in FIG. 12, electrical charging lines of the first power generator 30 and the second power generator 40 may be connected to a storage battery 91 in parallel, on/off contact parts 92 that determine whether to charge the storage battery 91 may be formed on the electrical charging lines, and the on/off contact parts 92 may be controlled to be turned on or off by a control switch 93 of a control terminal (not shown).

As described above, as illustrated in FIGS. 1 to 12, in the power generation system assembly using solar and wind power according to the embodiment of the present invention, the storage battery 91 may be charged by the first power generator 30 using solar power, and/or the storage battery 91 may be charged by the second power generator 40 using wind power. In the power generation system, the second power generator 40 may be firmly fixed at the top and bottom in the space formed between the second upper panel 21 and the second lower panel 22 which constitute the second power generation structure 20 without using an additional fixing means, and the support member 50 of which the height is adjusted by the rotating tool 60 may be formed in a space under the second lower panel 22, and thus the second lower panel 22 can be prevented from sagging due to the weight of the second power generator 40.

That is, as illustrated in FIG. 10, the rotating tool 60 may rotate the lifting and lowering support 52 of the support member 50 in the first direction (clockwise) to raise the lifting and lowering support 52, and as illustrated in FIG. 11, by changing a position of the rotating tool 60 by 180°, the rotating tool 60 may rotate the lifting and lowering support 52 of the support member 50 in the second direction (counterclockwise) to lower the lifting and lowering support 52, thereby stably supporting the second lower panel 22 on which the second power generator 40 is disposed.

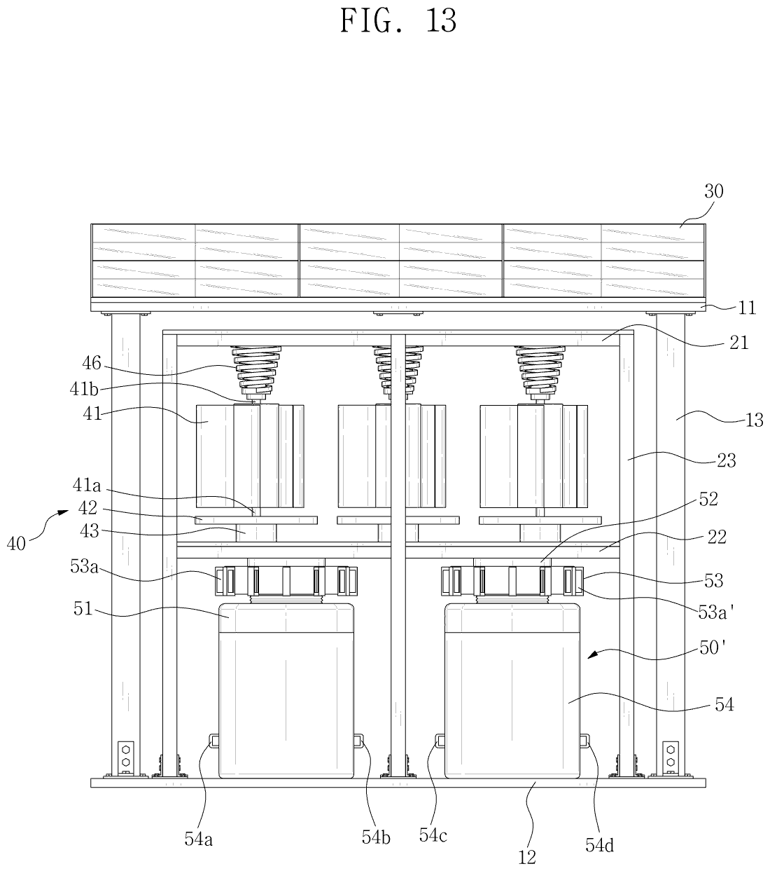

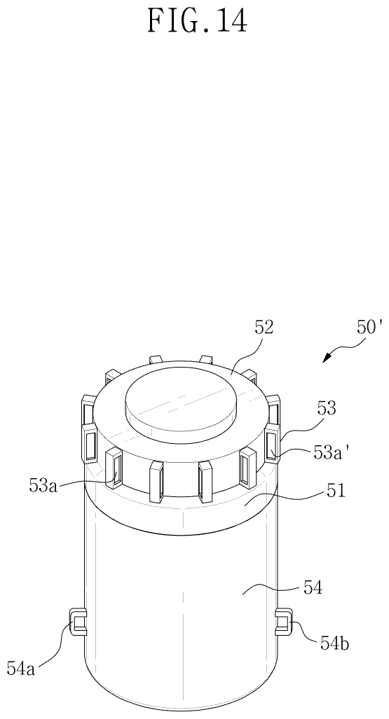

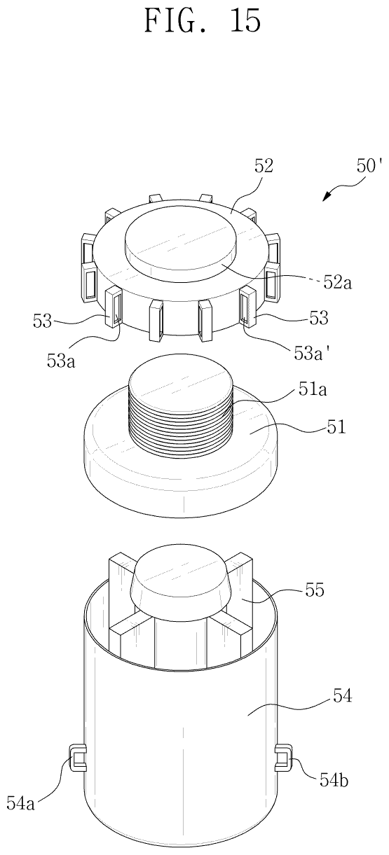

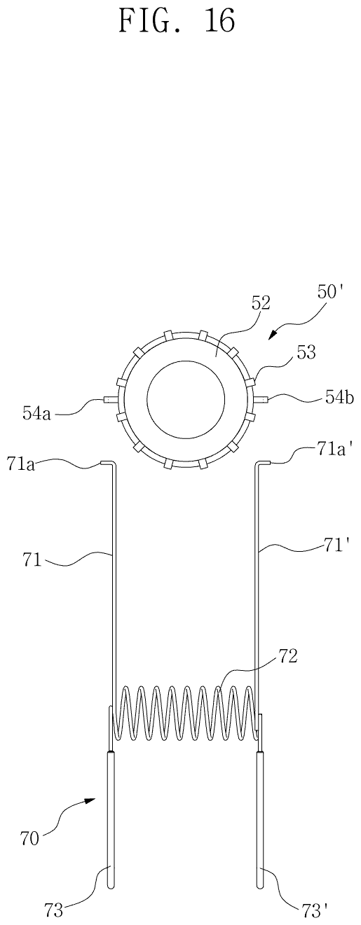

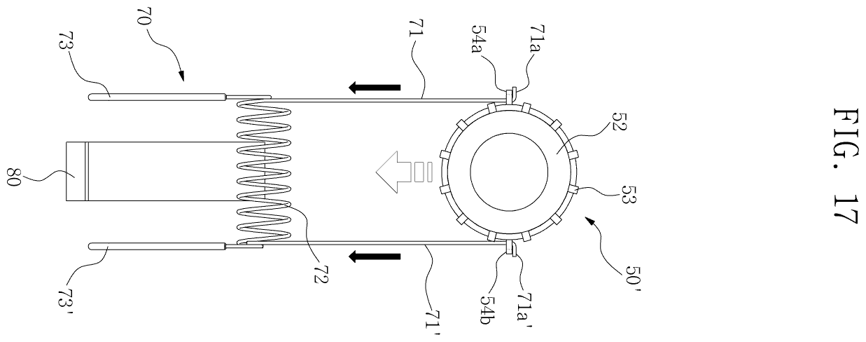

Meanwhile, FIGS. 13 to 17 are views illustrating a support member 50′ according to another embodiment of the present invention, which is intended to correspond to an increased height between a second upper panel 21 and a second lower panel 22 constituting a second power generation structure 20 when the height increases.

That is, the support member 50′ includes a cylindrical portion 54 which is disposed on the first lower panel 12 and whose upper portion is open, a reinforcing part 55 formed in an inner space of the cylindrical portion 54, a fixed support 51 having an upper end at which a first spiral portion 51a is formed and having a cover shape for sealing the open upper portion of the cylindrical portion 54, a lifting and lowering support 52 in which a second spiral portion 52a corresponding to the first spiral portion 51a is formed on an inner surface of the lifting and lowering support 52, and a height of the lifting and lowering support 52 is adjusted by being tightened or loosened by the rotating tool 60 so as to come into contact with the second lower panel 22, and rotation guide protrusions 53 which are formed at predetermined intervals to protrude from an outer surface of the lifting and lowering support 52 and in which catching grooves 53a and 53a′ fastened to both ends of the rotating tool 60 are formed at one side and the other side of each of the rotation guide protrusions 53, thereby corresponding to the increased height.

In this case, quadrangular ring parts 54a, 54b, 54c, and 54d for allowing the support member 50′ to be moved using a separating tool 70 may be formed to protrude from both lower end sides of an outer circumferential surface of the cylindrical portion 54 to form a symmetrical structure.

Here, the separating tool 70 may include a pair of separating rods 71 and 71′ in which hooking protrusions 71a and 71a′ to be caught in the ring parts 54a, 54b, 54c, and 54d of the fixed support 51 or the cylindrical portion 54 are formed at one ends of the separating rods 71 and 71′, a coil spring 72 from which the separating rods 71 and 71′ extend and which guides the widening or narrowing movement of the separating rods 71 and 71′, left and right handles 73 and 73′ formed at both ends of the coil spring 72, and a pedal 80 for restricting the movement of the cylindrical portion 54.

That is, in another embodiment of the present invention, when the cylindrical portion 54 is located under the second lower panel 22, the cylindrical portion 54 is fixed such that movement of the cylindrical portion 54 is restricted by the pedal 80, but when the cylindrical portion 54 is separated and removed from under the second lower panel 22, the cylindrical portion 54 is pulled using the separating tool 70 such that the support member 50′ including the cylindrical portion 54 may be separated from a space under the second lower panel 22.

Hereinafter, components the same as those in FIGS. 1 to 12 illustrating the above embodiment of the present invention are assigned the same reference numbers, and repeated descriptions thereof will be omitted.

As described above, the present invention is provided such that a power generator using solar power and a power generator using wind power can be installed in a stacked manner or an installation location of the power generator using the wind power can be changed as needed, and thus an effect of reducing an installation area of a plurality of power generators can be expected.

As described above, while the technical spirit of the power generation system assembly using solar and wind power of the present invention has been described with reference to the accompanying drawings, this is only an illustrative description of exemplary embodiments of the present invention and does not limit the present invention.

Accordingly, the present invention is not limited to the above-described specific exemplary embodiments and may be variously modified by those skilled in the art without departing from the gist of the invention claimed by the appended claims, and the modifications are within the scope of the claims.

What is claimed is:

1. A power generation system assembly using solar and wind power, comprising:
a first power generation structure in which a first power generator using solar power is disposed and which is formed by a combined structure of a first upper panel, a first lower panel, and a first support;
a second power generation structure in which a second power generator using wind power is disposed and which is formed by a combined structure of a second upper panel, a second lower panel, and a second support such that the second power generator is disposed in or separated from an inner space of the first power generation structure; and
a support member which is provided between the first lower panel and the second lower panel to prevent the second lower panel from sagging due to a weight of the second power generator when the second power generation structure in which the second power generator is disposed is disposed in the inner space of the first power generation structure.

2. The power generation system assembly of claim 1, wherein the second power generator includes:
a blade having one end and the other end from which shaft parts are formed to protrude and rotated by wind flowing into a space between the second upper panel and the second lower panel;
a rotor which is rotated by the shaft part formed to protrude from the one end of the blade and in which a through hole through which the shaft part passes is formed in a central portion of the rotor and a plurality of magnets are disposed on a surface of the rotor adjacent to the through hole as a center; and
a stator which is fixed in contact with the second lower panel and faces the rotor, in which a first bearing to which the shaft part passing through the through hole is coupled is formed in a central portion of the stator and a stator coil is disposed on a surface of the stator adjacent to the first bearing as a center, and which generates electrical energy according to the rotation of the rotor.

3. The power generation system assembly of claim 2, wherein:
a fixed plate is provided in contact with one surface of the second upper panel;
a second bearing coupled to the shaft part formed to protrude from the other end of the blade is connected to the fixed plate; and
the fixed plate and the second bearing are connected to a rubber elastic spring which prevents the rotor from being separated from the stator.

4. The power generation system assembly of claim 1, wherein the support member includes:
a fixed support having an upper end at which a first spiral portion is formed and disposed on the first lower panel;
a lifting and lowering support having an inner surface on which a second spiral portion corresponding to the first spiral portion is formed and of which height is adjusted by being tightened or loosened by a rotating tool so as to come into contact with the second lower panel; and
rotation guide protrusions which are formed at predetermined intervals to protrude from an outer surface of the lifting and lowering support and in which catching grooves fastened to both ends of the rotating tool are formed at one side and the other side of each of the rotation guide protrusions.

5. The power generation system assembly of claim 1, wherein the support member includes:
a cylindrical portion which is disposed on the first lower panel and of which upper portion is open;
a reinforcing part formed in an inner space of the cylindrical portion;
a fixed support having an upper end at which a first spiral portion is formed and having a cover shape for sealing the open upper portion of the cylindrical portion;
a lifting and lowering support having an inner surface on which a second spiral portion corresponding to the first spiral portion is formed and of which height is adjusted by being tightened or loosened by a rotating tool so as to come into contact with the second lower panel; and
rotation guide protrusions which are formed at predetermined intervals to protrude from an outer surface of the lifting and lowering support and in which catching grooves fastened to both ends of the rotating tool are formed at one side and the other side of each of the rotation guide protrusions.

6. The power generation system assembly of claim 4, wherein the rotating tool includes:
a linear rotating rod having a wedge part that is formed at one end thereof comes into contact with the catching groove formed at the one side or the other side of the rotation guide protrusion to push the rotation guide protrusion to rotate the lifting and lowering support in a first direction or a second direction opposite to the first direction;
a hook-shaped rotating rod having a hooking protrusion that is formed at one end thereof and is caught in the catching groove formed at the one side or the other side of the rotation guide protrusion to catch and pull the rotation guide protrusion to rotate the lifting and lowering support in the first direction or the second direction opposite to the first direction;
a coil spring from which the linear rotating rod and the hook-shaped rotating rod extend in parallel and which guides widening or narrowing movement of the linear and hook-shaped rotating rods; and
left and right handles formed at both ends of the coil spring.

7. The power generation system assembly of claim 5, wherein the rotating tool includes:
a linear rotating rod having a wedge part that is formed at one end thereof comes into contact with the catching groove formed at the one side or the other side of the rotation guide protrusion to push the rotation guide protrusion to rotate the lifting and lowering support in a first direction or a second direction opposite to the first direction;
a hook-shaped rotating rod having a hooking protrusion that is formed at one end thereof and is caught in the catching groove formed at the one side or the other side of the rotation guide protrusion to catch and pull the rotation guide protrusion to rotate the lifting and lowering support in the first direction or the second direction opposite to the first direction;
a coil spring from which the linear rotating rod and the hook-shaped rotating rod extend in parallel and which guides widening or narrowing movement of the linear and hook-shaped rotating rods; and
left and right handles formed at both ends of the coil spring.

8. The power generation system assembly of claim 1, wherein the support member is separated by a separating tool,
wherein the separating tool includes:
a pair of separating rods having hooking protrusions formed at one ends to be caught in ring parts of a fixed support or a cylindrical portion;
a coil spring from which the pair of separating rods extend in parallel and which guides widening or narrowing movement of the separating rods; and
left and right handles formed at both ends of the coil spring.

9. The power generation system assembly of claim 1, wherein:
electrical charging lines of the first power generator and the second power generator are connected to the storage battery in parallel;
on/off contact parts that determine whether to charge the storage battery are formed on the electrical charging lines; and
the on/off contact parts are controlled to be turned on or off by a control switch of a control terminal.
